(19) United States
(12) Patent Application Publication
(10) Pub. No.: US 2008/0295153 A1
(43) Pub. Date: Nov. 27, 2008

(54) SYSTEM AND METHOD FOR DETECTION AND COMMUNICATION OF COMPUTER INFECTION STATUS IN A NETWORKED ENVIRONMENT

(76) Inventors: Zhidan Cheng, Cupertino, CA (US); Yishin Chung, Palo Alto, CA (US); Ofer Doitel, Woodside, CA (US); Richard Dudgeon, San Mateo, CA (US)

Correspondence Address: SCHWEGMAN, LUNDBERG & WOESSNER, P.A., P.O. BOX 2938, MINNEAPOLIS, MN, 55402, US

(21) Appl. No.: 11/753,470

(22) Filed: May 24, 2007

(51) Int. Cl. H04L 9/32

(52) U.S. Cl. 726/3

(57) ABSTRACT

Methods and systems for detection and communication of computer infection status in a networked environment are disclosed. In example embodiments, a network device includes a detection component to detect the presence of unwanted software in a networked computer from the network device not resident in the networked computer, a dispatch component to dispatch an infection notification for communication to the networked computer, and a communication component to handle communication with a user of the infected computer.

### TECHNICAL FIELD

The inventive subject matter relates generally to computers, software and networked communication and more specifically to systems and methods for detection and communication of computer infection status in a networked environment.

### BACKGROUND

Currently, software and system products are available to detect and remove malware from computers. A computer malware is a computer program that can copy itself or infect a computer without permission or knowledge of the user. Malware can spread from one computer to another when its host is taken to the uninfected computer, for instance by a user sending it over a network or carrying it on a removable medium such as a floppy disk, CD, or USB drive. Additionally, Malware programs can spread to other computers by infecting files on a network file system or a file system that is accessed by another computer. Many personal computers are now connected to the Internet and to local-area networks, facilitating the spread of malware. Some sources use an alternative terminology in which a malware is any form of self-replicating malware. The common use of the term malware including various forms of unwanted software, such as virus, spyware, adware, spam, denial of service attacks, and the like are also more common with network-connected computers.

Although existing systems can detect and remove malware from a computer, these systems operate as software resident on the computer itself. However, there are significant benefits for detection of malware in the network. It is be more efficient to detect and remove malware in the network as the first layer of defense, before the malware infects and damages the victim computer. Further, a single protecting device on a network provides attractive economic benefits as it saves the labor of installing and administering protective software on multiple computers. In addition, it is possible that some unwanted software cannot be detected effectively without visibility to malware behaviors across many computers. However, software not resident in a particular computer may have problems communicating with a user of the computer if a malware alert notification must be sent.

### BRIEF DESCRIPTION OF THE DRAWINGS

Some embodiments are illustrated by way of example and not limitation in the figures of the accompanying drawings in which:

FIG. 1 is a high-level diagram depicting an example inline mode system within which an example embodiment may be used;

FIG. 2 is a high-level diagram depicting an example port span/tap mode system within which an example embodiment may be used;

FIG. 3 is a system diagram illustrating an example embodiment of a flow of operations performed in a particular example configuration;

FIG. 4 is a block diagram illustrating an example embodiment of a particular example configuration and the internal modules of the unwanted software detection system in a particular example configuration;

FIG. 5 is a screen shot depicting an infection notification web page for an example embodiment;

FIG. 6 is a high-level processing flow diagram illustrating a method in an example embodiment;

FIG. 7 is a block diagram illustrating a diagrammatic representation of a machine in the example form of a computer system.

### DETAILED DESCRIPTION

Example methods and systems for detection and communication of computer infection status in a networked environment are described. In the following description, for purposes of explanation, numerous specific details are set forth in order to provide a thorough understanding of example embodiments. It will be evident, however, to one of ordinary skill in the art that the present invention may be practiced without these specific details.

End user computers may get infected with spyware, malware or any other unwanted software. In various embodiments described herein, the inventors have devised systems and methods to detect such infections over the network and consequently notify the end users of the presence of such infections in their computer. In an example embodiment, a network system device is provided to inspect network transmissions and network behaviors of computers communicating on the network. Upon detection of unwanted software in a network-connected computer, the network system device alerts a user of an infected computer of the presence of unwanted software.

### Example System Architecture

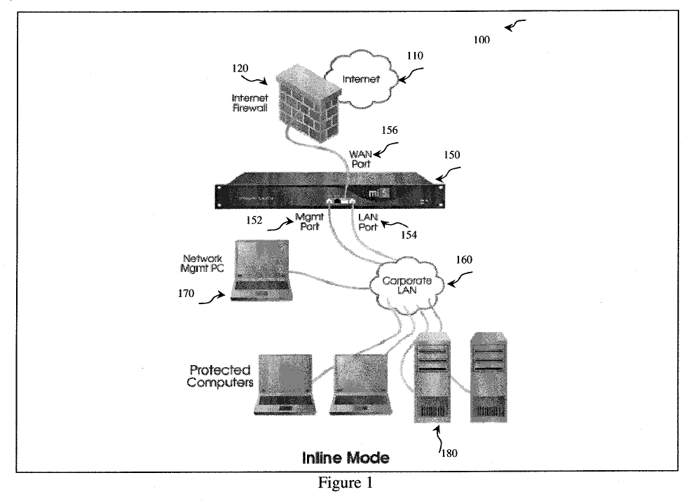

FIG. 1 is a high level diagram depicting an example embodiment of an Inline operation mode of a system 100 for detecting unwanted software in a corporate LAN linked to the Internet. The example system 100 may include an unwanted software detection system 150, network computers 180, a corporate LAN 160, an optional network management computer 170, an optional internet firewall 120 and the Internet 110. The unwanted software detection system 150 may be directly connected to the Internet 110 without the use of firewall 120.

In an example embodiment, the unwanted software detection system 150 may include a management port 152, a LAN port 154, and a WAN port 156. The configuration shown in FIG. 1 illustrates an inline mode of operation, in which the unwanted software detection system 150 is located in between the Internet firewall and the corporate LAN 160. In other words, all the traffic between the Internet and the corporate LAN 160 must pass through the unwanted software detection system 150.

According to example embodiments, the unwanted software detection system 150 may be connected to the Internet via a WAN port 156. The link between the corporate LAN 160 and the Internet is provided by the unwanted software detection system 150 through the LAN port 154. The corporate LAN 160, network computers 180, and the network management computer 170 may be protected by the unwanted software detection system 150. The unwanted software detection system 150 may monitor the activities associated with the network computers 180 through the LAN port 154 and the WAN port 156. The unwanted software detection system 150 may detect unwanted software activities associated with the network computers 180 and attribute unwanted software types (e.g., Trojan, Keylogger, Virus, Worm, and the like).

In example embodiments, the unwanted software detection system 150 may detect one or more additional unwanted software activities associated with the network computers 180. The unwanted software detection system 150 may update the unwanted software types associated the network computers 180, based on the unwanted software activity associated with the subsequent unwanted software

According to example embodiments, the unwanted software detection system 150 may record timestamps (e.g., time of occurrence) associated with one or more unwanted software activities of the network computers 180. The one or more other criteria used by the unwanted software detection system 150 may include the timestamp associated with one or more additional unwanted software activities, detected by unwanted software detection system 150. In example embodiments, the network activities associated with the network computers 180 may include network transmissions and network behavioral patterns. However, the unwanted software detection system 150 does not need to install any software on the network computers 180 or use any software already installed on the network computers 180, in order to detect unwanted software activities.

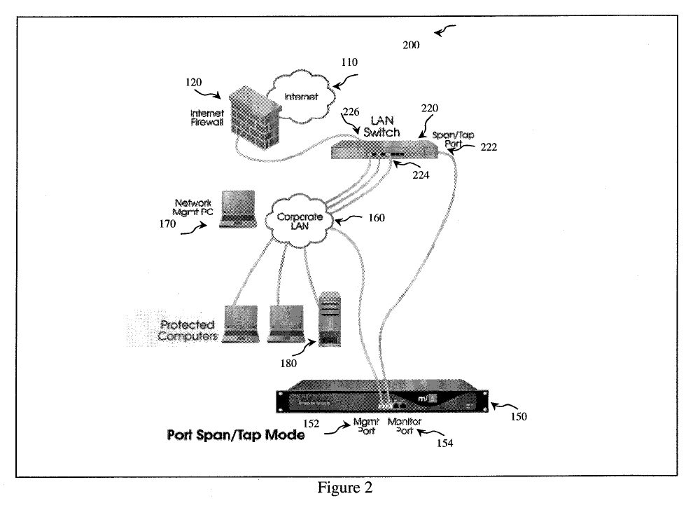

FIG. 2 is a high level block diagram illustrating an example embodiment of a Port Span/Tap operation mode of a system 200 for detecting unwanted software in a corporate LAN linked to the Internet. In the example port span/tap mode operation illustrated in FIG. 2, the network computers 180 and the optional network management computer 170 may be linked through the corporate LAN 160 and may be connected to the Internet via a LAN switch or hub 220 protected by the Internet firewall 120. The LAN switch 220 may be connected to the Internet firewall through the connection port 226 and to the corporate LAN 160 through the connections port 224. The LAN switch 220 is capable of providing a copy of the corporate LAN network 160 traffic over a port span/tap 222.

In the example configuration shown, the unwanted software detection system 150 may be connected through a connection between the LAN port 154 and the port span/tap 222 on the LAN switch 220. This configuration may be advantageous in the sense that the unwanted software detection system 150, may inspect all traffic between/from/to the network computers 180, while not being in the way of the traffic, therefore, not affecting the corporate LAN 160 throughput and connection speed by introducing additional latency.

In general, the unwanted software detection system 150 detects all unwanted software coming into or out of the enterprise connected through the corporate LAN 160. Optional Prevention Policies enable a system administrator to configure the system to take an action (e.g. Blocking) based on end-user address, activity severity, or specific activity. The system 150 can also be configured to apply exclusively a Monitoring or a Blocking mode. When configured in a Blocking mode, the system 150 can actively prevent unwanted software from communicating on the network. When configured in a Monitoring mode, the system 150 can merely watch and record the activities of unwanted software and report the activity to an administrator or end user. The implementation of Prevention policies enable a mixed mode of blocking and monitoring where the optional policy determines the action to be applied.

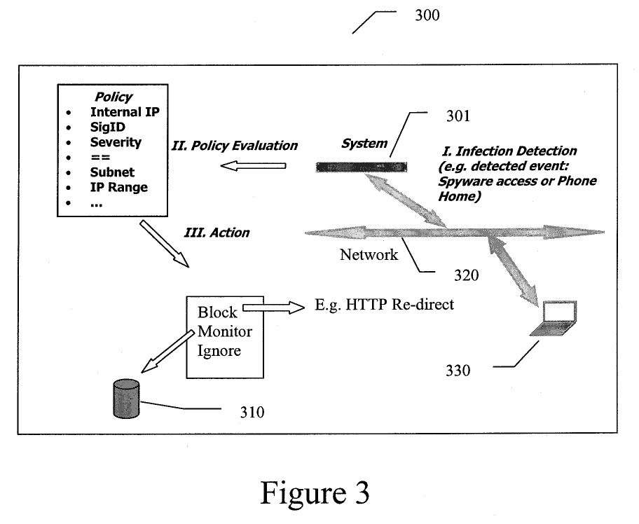

FIG. 3 is a system diagram illustrating an example embodiment of a flow of operations performed in configuration 300. In general, the unwanted software detection system 301 detects all unwanted software coming into or out of the network computers 330. As described above in connection with FIGS. 1 and 2, the unwanted software detection system 301 is connected to a network 320. End user computers (network computers) 330 are also connected to a network 320. In a first step of infection detection I, unwanted software detection system 301 detects events, activities, phone home communications, or other behaviors known to be associated with unwanted software in one or more network computers 330. In an optional second step of policy evaluation II, unwanted software detection system 301 determines how to process the detected unwanted software based on a set of pre-configured policies. An example of a few of these optional policies in a particular embodiment is provided below.

### I. Prevention Policies:

1. Block on Severity

e.g. Block access to all Spyware with Severity>=Critical, Monitor Otherwise
2. Block if end-user's IP address belongs to a Subnet

e.g. Blocking Mode for subnet x,y,z, Monitoring Otherwise
3. Block if end-user's IP address is within IP address range

e.g. Blocking Mode for IP Address: x.y.z.n-m, Monitoring Otherwise
4. Ignore if IP is in subnet x.y.z and SgID=zzzzz

e.g. Ignore SigID zzzzz for subnet x.y.z
5. Combination: Subnet/IP range and Severity

e.g. Block spyware for subnet x.y.z when spyware Severity=Critical

Based on these and other policies, unwanted software detection system 301 can take an appropriate action in a third action step III. These actions can include blocking the unwanted software (e.g. using an HTTP re-direct), monitoring and recording the activities of the unwanted software, or ignoring the activities of the unwanted software.

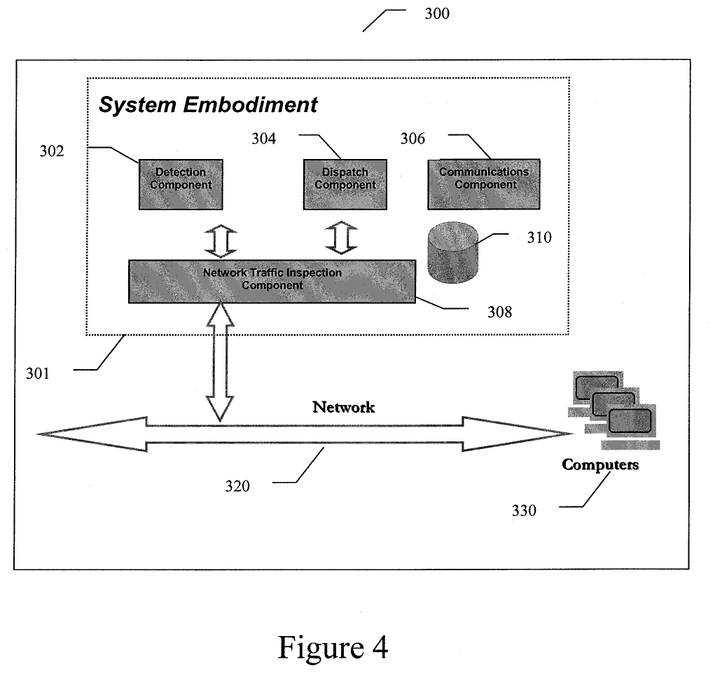

FIG. 4 is a block diagram illustrating an example embodiment of a configuration 300 and internal modules of unwanted software detection system 301. In the system 301 shown in FIG. 4, unwanted software detection system 301 is shown to include a detection component 302, a dispatch component 304, a communications component 306 and a network traffic inspection component 308. The unwanted software detection system 301 is also shown to include a data store 310. As described above in connection with FIGS. 1 and 2, the unwanted software detection system 301 is connected to a network 320. End user computers (network computers) 330 are also connected to the network 320.

As described in detail below, unwanted software detection system 301 may detect unwanted software activities associated with the network computers 330. Unwanted software detection system 301 can detect unwanted software by inspecting network transmissions and network behaviors of network computers 330. The detection processing of unwanted software detection system 301 is handled by detection component 302. In general, detection component 302 inspects network traffic for computer infections, spyware, and the like. The detection component 302 can use network traffic inspection component 308 to decode network packets and identify particular computers associated with the data packets. In a particular embodiment, this detection processing includes the following operations.
1. Following the detection of the existence of an infection on a network computer, detection component 302 saves a log of the activity/circumstances into a database 310 with the details of the infection and the identifier (ID) of the infected computer.
2. For any “infected” network computer or based on any other system configurable policy (e.g. information, remediation, prevention, etc.), an instruction is issued for “infection-notification” to be communicated to the infected computer.
3. The issuance of an infection-notification instruction may be repeated based on time configuration.

Once the detection component 302 has detected unwanted software and initiated an infection notification, unwanted software detection system 301 may dispatch the infection notification for communication to the appropriate network computer 330 using dispatch component 304. Because the manner of communicating the infection notification to the appropriate network computer 330 may change based on a variety of factors including time, frequency of notice, severity of infection, type of infection, and the like, the dispatch component 304 is needed to appropriately dispatch the infection notice. The dispatch component 304 can use network traffic inspection component 308 to decode network packets and identify particular computers associated with the data packets. In a particular embodiment, this dispatch processing includes the following operations.
1. Work-hours definition may be checked against actual time to optionally perform dispatch only during work hours.
2. The computer ID associated with the origination of a data packet is checked to determine if an outstanding instruction for infection-notification exist
3. A packet analysis is performed to determine if the transmission is generated by a legitimate browser application.
4. A test is performed to verify that the transmission is not performed by spyware, malware etc.
5. An optional test may be performed that a minimal pre-determined time threshold has passed since the last dispatch to this computer.
6. If the above conditions are met, the end user browser session is hijacked and is redirected to an infection-notification web page for Communications.

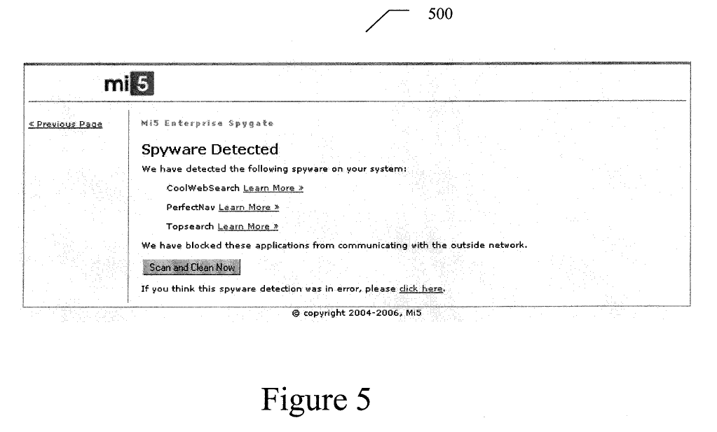

Once the dispatch component 304 has dispatched the infection notification for communication to the appropriate network computer 330, the communications component 306 handles communication with the infected network computer. As described above, dispatch component 304 can perform various tests to determine if the infection notification should be communicated to the user of the infected computer at this particular time. If dispatch component 304 determines that the infection notification should be communicated to the user of the infected computer at this particular time, the end user browser session is hijacked and is redirected to an infection-notification web page. The end user browser session is hijacked using a variety of techniques. In one example embodiment, the unwanted software detection system 301 can detect the session ID of the infected computer and the IP address to which the infected computer is attempting to communicate. This information can be used to redirect the infected computer to an infection-notification web page. An example infection notification web page is illustrated as page 500 in FIG. 5.

Upon receipt of an infection-notification web page request from a given computer, the communications component 306 can perform several processing operations as set forth below.
1. A test is performed to determine the capabilities of the end user browser (such as the ability to run ActiveX).
2. Based on the computer ID, the list of active “Infections” (which were not marked repaired yet) is retrieved from the data base 310 log and presented to the end user.
3. It is optional to present the end user with remediation options based on configuration, their browser capabilities, policies etc.: As shown in web page 500 in FIG. 5, the user is given an option to scan and clean the unwanted software from the infected computer by selecting the button 501. Upon selection of this button, the communications component 306 handles the dispatch of remediation to this computer.
4. If a distinctive user action is taken, the infection-notification instruction is removed. If the user elects to repair/clean the unwanted software shown on the list of active “Infections” (which were not marked repaired yet), the unwanted software is repaired/cleaned and marked as such in the data base 310 log. Otherwise, the data base 310 log retains the list of active “Infections” as still not repaired/not cleaned.

The communications component 306 can thus assist the user of the infected computer to remove unwanted software form the infected computer without requiring the user to install any software on the infected computer. In this manner, the removal of the unwanted software on a computer 330 can be performed from the network device 301 without any client software installed on the desktop of the computer 330. Further, because the network device 301 can hijack an end user browser session on a computer 330, the infection notification can be automatically sent to the end user without the end user having to actively check infection status.

The various embodiments described herein provide systems and methods for detection and communication of computer infection status in a networked environment. The described system combines knowledge about infection on a computer with the ability to communicate with the end-user of that computer. Because the network device 301 is resident in the network and not on a particular networked computer 330, the network device 301 is able to scan network traffic to/from a variety of different computers 330. As such, network device 301 can detect malware activities and behaviors not detectable by software resident in a particular computer 330. Further, the network device 301 can intelligently dispatch and communicate an infection notification to the infected computer user. The network device 301 can dispatch the infection notification to the infected computer user in a manner and at a time that maximizes the probability of displaying the infection notification to a live end user. The network device 301 can qualify the end user browser application to determine the probability of displaying the infection notification to a live end user. Further, the time of infection detection and the time of notification to end users can vary greatly to provide effective and convenient user communication. Because the network device 301 can log infection notifications in data store 310, the end user can resolve more than one infection with each infection notification. This feature improves user efficiency. This feature also enables the system to detect patterns of infection over time and over one or more networked computers 330.

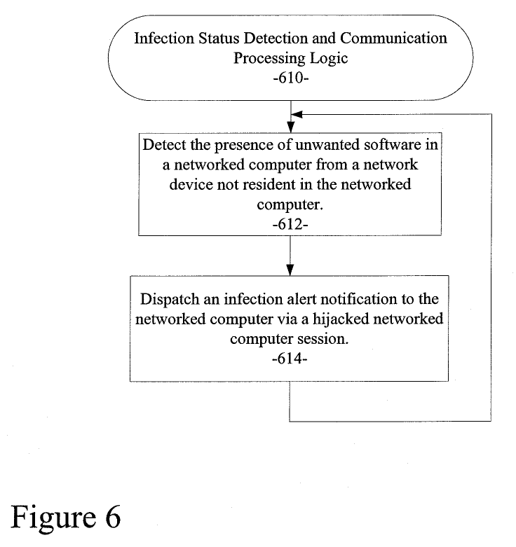

FIG. 6 is a processing flow diagram in an example embodiment. In processing block 612, the network device 310 detects the presence of unwanted software in a networked computer from a network device 310 not resident in the networked computer. In processing block 614, the network device 310 dispatches an infection alert notification to the networked computer via a hijacked networked computer session.

### Machine Architecture

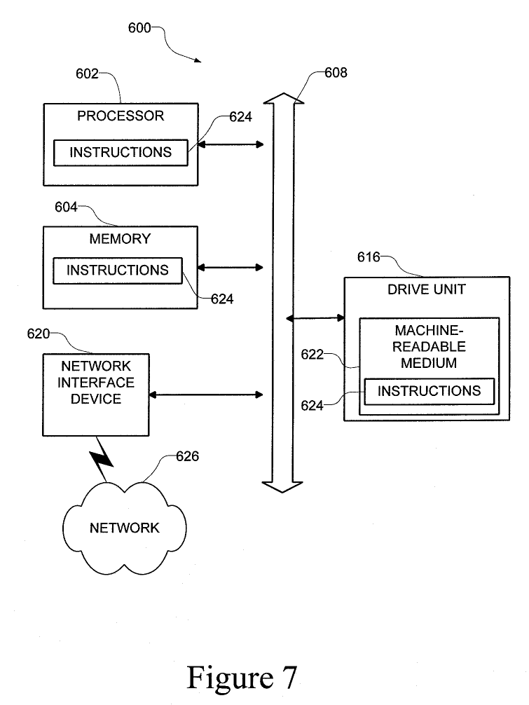

FIG. 7 is a block diagram, illustrating a diagrammatic representation of machine 600, in the example form of a computer system within which a set of instructions, for causing the machine to perform any one or more of the methodologies discussed herein, may be executed. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 may include a processor 602 (e.g., a central processing unit (CPU)) and a memory 604, which communicate with each other via a bus 608. The computer system 600 may further include a disk drive unit 616 and a network interface device 620.

The disk drive unit 616 may include a machine-readable medium 622 on which is stored one or more sets of instructions (e.g., software 624) embodying any one or more of the methodologies or functions described herein. The software 624 may also reside, completely or at least partially, within the memory 604 and/or within the processor 602 during execution thereof by the computer system 600, the memory 604 and the processor 602 also constituting machine-readable media. The software 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

Thus, methods and systems for detection and communication of computer infection status in a networked environment are disclosed. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method comprising:
detecting the presence of unwanted software in a networked computer from a network device not resident in the networked computer; and
dispatching an infection alert notification to the networked computer via a hijacked networked computer session.

2. The method of claim 1 including redirecting a user of the networked computer to a web page containing the infection alert notification.

3. The method of claim 1 including prompting a user of the networked computer of unwanted software residing on the networked computer.

4. The method of claim 1 including prompting a user of the networked computer to initiate removal of the unwanted software from the networked computer.

5. The method of claim 1 including logging the detection of the unwanted software in a data store connected to the network device.

6. The method of claim 1 including processing the detection of the unwanted software according to a pre-configured policy.

7. A network device comprising:
a detection component to detect the presence of unwanted software in a networked computer from the network device not resident in the networked computer;
a dispatch component to dispatch an infection notification for communication to the networked computer; and
a communication component to handle communication with a user of the infected computer.

8. The network device of claim 6 being configured to redirect a user of the networked computer to a web page containing the infection alert notification.

9. The network device of claim 6 being configured to prompt a user of the networked computer of unwanted software residing on the networked computer.

10. The network device of claim 6 being configured to prompt a user of the networked computer to initiate removal of the unwanted software from the networked computer.

11. The network device of claim 6 being configured to log the detection of the unwanted software in a data store connected to the network device.

12. The network device of claim 6 being configured to process the detection of the unwanted software according to a pre-configured policy.

13. A machine-readable medium embodying instructions, the instructions, when executed by a machine, causing the machine to:
detect the presence of unwanted software in a networked computer from a network device not resident in the networked computer; and
dispatch an infection alert notification to the networked computer via a hijacked networked computer session.

14. The machine-readable medium of claim 11 being configured to redirect a user of the networked computer to a web page containing the infection alert notification.

15. The machine-readable medium of claim 11 being configured to prompt a user of the networked computer of unwanted software residing on the networked computer.

16. The machine-readable medium of claim 11 being configured to prompt a user of the networked computer to initiate removal of the unwanted software from the networked computer.

17. The machine-readable medium of claim 11 being configured to log the detection of the unwanted software in a data store connected to the network device.

18. The machine-readable medium of claim 11 being configured to process the detection of the unwanted software according to a pre-configured policy.
